(19) United States
(12) Patent Application Publication
(10) Pub. No.: US 2025/0363481 A1
(43) Pub. Date: Nov. 27, 2025

(54) A GRATUITY SYSTEM

(71) Applicants: Kimlynn Temple, Irene, Centurion (ZA); Robin Coode, Zwavelkloof (ZA)

(72) Inventors: Kimlynn Temple, Irene, Centurion (ZA); Robin Coode, Zwavelkloof (ZA)

(21) Appl. No.: 18/994,691

(22) PCT Filed: Jul. 17, 2023
(86) PCT No.: PCT/ZA2023/050035

§ 371 Date: Jan. 15, 2025

(30) Foreign Application Priority Data
Jul. 15, 2022 (ZA) 2022/07864

(51) Int. Cl. G06Q 20/36

(52) U.S. Cl. CPC G06Q 20/367

(57) ABSTRACT

A gratuity system (10) including a database (12) containing a profile (14) of a registered user (16) which includes identification information of the registered user (16), and details (18) of an account in the form of a digital wallet (20) linked to the registered user (16), and a unique identifier (22) associated with the user profile (14) for allowing identification of the registered user (16) and corresponding account details (18) by a banking institution (24) used by a payer (26) in order to permit a gratuity payment (28) from the payer (26) into the account, typically in the form of a digital wallet (20), of the registered user (16).

### TECHNICAL FIELD

This invention relates to a gratuity system. In particular, this invention relates to a digital gratuity system for enabling digital gratuity payments.

### SUMMARY OF THE INVENTION

According to the invention, there is provided a gratuity system including:—
a database containing a profile of a registered user which includes:—
   identification information of the registered user; and
   details of an account linked to the registered user; and
a unique identifier associated with the user profile for allowing identification of the registered user and corresponding account details by a banking institution used by a payer in order to permit a gratuity payment from the payer into the account of the registered user.

The database may be in the form of a data storage device which may be in the form of any one or more of the group including an HDD (Hard Disk Drive), SSD (Solid State Drive), external hard drive, USB flash drive, memory card, optical disc, magnetic tapes, NAS (Network Attached Storage), server, peer-to-peer network, cloud storage, and RAID (Redundant Array of Independent Disks), preferably being in the form of a cloud-based storage.

A registration means may be provided for allowing a user to sign up and create a user profile for use with the gratuity system. The registration means may include a verification means for verifying the identity of a user desirous of registering. The verification means may be configured to compare input identification details against those contained on an official database whereupon matching of details typically yields successful verification. The official database may be in the form of a governmental database or a financial database managed by a banking institution. The registration means may be configured to create the user's profile, account and unique identifier and store the associated information on the database. It is to be appreciated that the registration means may be configured to comply with the FICA (Financial Intelligence Centre) Act 38 of 2001 of South Africa when registering a user. The registration means may be remotely operable wherein users are able to use a dedicated application installed on a mobile device or a webpage accessible by an internet browser to carry out the registration process.

The identification information of the registered user may include any one or more of the group including name, full names, surnames, identification number, passport number, residential address, employer address, e-mail address, and phone number. The identification information may include biometric information of the registered user. The biometric information may include any one or more of the group including a fingerprint, facial scan, eye scan, voice recording, and the like.

The account may be in the form of a bank account. The bank account may be in the name of the registered user. Preferably, the bank account may be in the name of a digital wallet service provider. The digital wallet service provider may provide a digital wallet to registered users. The digital wallet service provider may provide hosting and management services in relation to the digital wallets. The bank account may be held with any suitable banking institution. The details of the account may include account information of the bank account of the digital wallet service provider and identification information of the registered user's specific digital wallet. It is to be appreciated that both account information and digital wallet identification information is required in order to effect payment into the bank account of the digital wallet service provider and reflect the payment in the digital wallet of the registered user. The details of the account may include any one or more of the group including associated banking institution, branch code, account type, account number, digital wallet identification code, and the like.

The account may be configured to receive conventional monetary payments or digital currency payments, the type of payment typically reflecting within the digital wallet of the registered user. The digital currency payments may be in the form of a cryptocurrency payment or a currency of a loyalty reward program. The loyalty reward program currency may be in the form of eBucks, Discovery Miles, and the like. The digital currency may be in the form of airtime.

The account may be configured to allow the registered user to transact with merchants or retailers, typically those associated with the gratuity system, at their till points. The account may be configured to allocate a percentage of funds to any one or more of the group including a retirement fund, pension fund, life insurance policy, funeral policy, disability fund, medical aid, education fund, loan, bond repayment, vehicle finance, financial services, financial advice, estate planning, debt counselling and the like. Funds in the digital wallet may be used to obtain shelter, beds, food, healthcare, and the like. It is to be appreciated that funds in the digital wallet can be used to pay for anything provided by a partnered goods or service provider.

A discount system may be provided for offering discounts to registered users using funds contained in their digital wallet to purchase goods or services. The discounts offered may be specific to any one or more of the group including a specific product, merchant, service, and service provider. An associated merchant or service provider may receive incentives for offering such discounts, such as receiving Social Development funding or receiving BBBEE points. Companies manufacturing products which are sold to registered users using funds in their digital wallet may provide rebates to specific stores stocking their products.

The registered user may be in the form of a worker performing a service. More specifically, the registered user may be in the form of any one or more of the group of workers including petrol attendants, security guards, car guards, waitrons, hotel staff, domestic staff, gardeners, flight cabin crew, cleaning staff, bartenders, golf caddies, drivers, beauticians, hair dressers, game rangers, domestic workers, buskers and the like. The registered user may be in the form of a company or a charitable or non-profit organisation. The registered user may be a minor, typically having completed a chore. It is to be appreciated that this particular functionality enables minors to develop financial literacy, work ethic, and responsibility while fostering independence and goal-setting through the earning and management of money for completing tasks. It is to be appreciated further that the above list is by no means exhaustive and many other individuals or groups may be suited to benefit from the gratuity system.

The registered user may be in the form of a group-type or representative user which may represent a plurality of associated workers or individuals. The group-type user may be registered by an employer having a plurality of employees, typically offering a similar or related service. The group-type user may include a plurality of linked registered users performing a similar or related service, wherein gratuity payments to the group-type user are split, preferably equally or proportionately, between the linked registered users. The gratuity payments may be split between linked registered users having completed a particular shift. For example, an owner of a petrol station may register the group-type user to represent a plurality of their petrol attendants so that at the end of a particular shift, all gratuity payments made to the group-type user are split up and paid into the accounts of the petrol attendants having completed their shifts. Alternatively, the group-type user may be in the form of a temporary, once off, group-type member wherein a single gratuity payment may be split between a desired number of registered users.

The group-type user or representative user may represent a group of people frequenting and/or residing in a particular area. The particular area may be in the form of an informal settlement or township. It is to be appreciated that in this case, unique identifiers may be placed in and around the particular area to enable gratuity payments in the form of donations to be paid into an account of a representative of the area. It is to be appreciated further that such gratuity payments may be utilised to improve any aspect of the particular area including amenities, infrastructure and any of the group of facilities including public, commercial, recreational, healthcare, educational, and cultural.

The group-type or representative user may represent a person or group of people running a particular business. The particular business may be in the form of any retailer or service provider.

The unique identifier may be machine-readable, preferably being in the form of a machine-readable image or code. Preferably, the unique identifier may be configured to be readable by a mobile computing device of the payer, wherein the mobile computing device may be in the form of any smart device, such as a tablet, smart phone, typically having a camera. Preferably, the unique identifier may be in the form of a QR (Quick Response) code.

Alternatively, the unique identifier may be in the form of a biometric identifier for allowing biometric recognition thereof. The biometric recognition may be in the form of any one or more of the group including facial, eye, voice, and fingerprint recognition.

Further alternatively, the unique identifier may be in the form of a device capable of communicating with a mobile computing device of the payer for transferring information and account details of the registered user to the mobile computing device to enable identification of the registered user by the payer's banking institution in order to set up and permit the gratuity payment. The device may be configured to transfer information to the mobile computing device of the payer upon bringing the respective devices into contact with each other. The device may be configured to utilise NFC (Near Field Communication) technology to transfer information. The device may be in the form of an RFID (Radio-Frequency Identification) tag, preferably being a passive RFID tag requiring no power source. The device may be in the form of a POS (Point of Sale) device.

The banking institution may be in the form of any suitable banking institution with which the payer utilises to manage its funds.

The payer may be in the form of any entity wishing to make a gratuity payment to a registered user, typically a worker or any other individual. Preferably, the payer is in the form of a member of the public having a mobile computing device capable of reading the unique identifier of the registered user and having a linked payment application installed on their mobile computing device. The linked payment application may be in the form of a banking application or a payment application such as, Snapscan or Zapper, for example.

The gratuity payment may be in the form of a conventional monetary payment. Alternatively, the gratuity payment may be in the form of a digital currency payment. The digital currency payment may be in the form of a payment of a cryptocurrency or payment of a unit of a loyalty reward program.

An incentivising means may be provided for incentivising the public to effect gratuity payments via the gratuity system. The incentivising means may be in the form of a reward system for rewarding a payer upon effecting a gratuity payment via the gratuity system. The reward system may be configured to issue a currency of a loyalty reward program to the payer. The reward system may be configured to issue a voucher or coupon to be used at an associated retailer. The incentivising means may include governmental subsidisation into a retirement fund, pension fund, unemployment fund, and the like. The incentivising means may include tax benefits wherein gratuity payments via the gratuity system are tax deductable, preferably wherein a certificate in terms of Section 18A of the Income Tax Act 58 of 1962 of South Africa is issued to the payer.

A recording means may be provided for recording performance statistics of employees who are registered users of the gratuity system. The performance statistics may include sales and gratuity information of the employees, preferably employees employed by a specific employer. The performance statistics may include KPIs (Key Performance Indicators) of the employees.

A purchase recording means may be provided for recording details of all purchases using funds contained in a registered user's digital wallet. Purchase details may include product information, price, store location, and the like.

### BRIEF DESCRIPTION OF THE DRAWINGS

A gratuity system in accordance with the invention will now be described by way of the following, non-limiting examples with reference to the accompanying drawings.

In the drawings:—

FIG. 1 is a flow diagram generally depicting the gratuity system in accordance with the present invention.

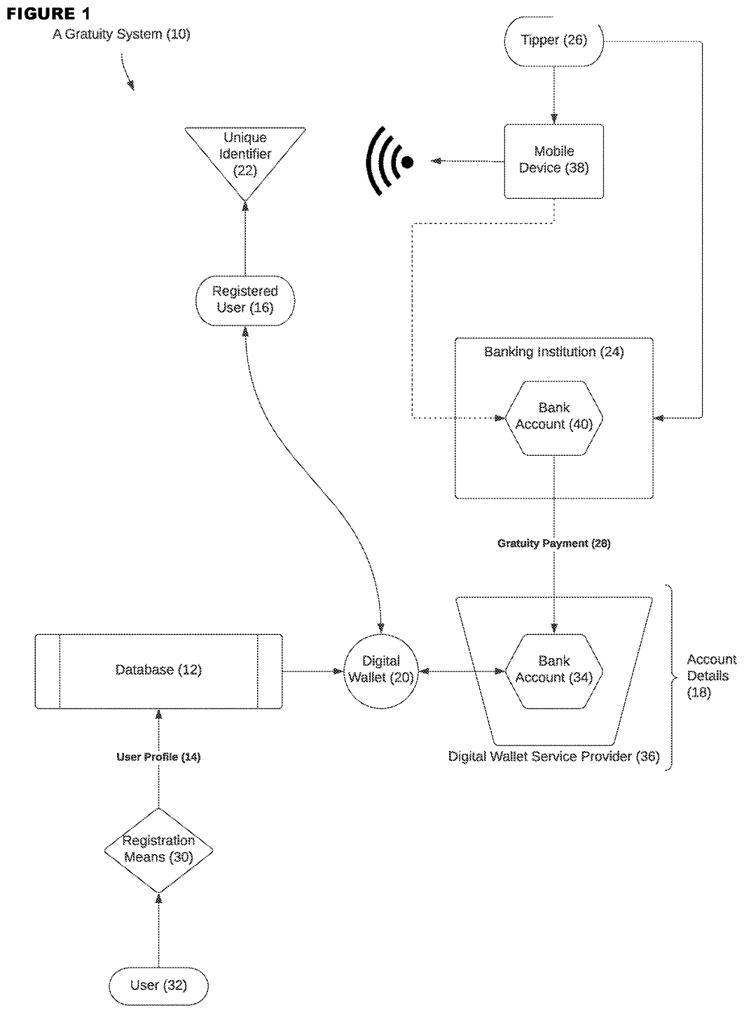

### DETAILED DESCRIPTION OF THE INVENTION

Referring now to the figures, reference numeral 10 refers generally to a gratuity system in accordance with the present invention. The gratuity system 10 includes a database 12 containing a profile 14 of a registered user 16 which includes identification information of the registered user 16, and details 18 of an account in the form of a digital wallet 20 linked to the registered user 16, and a unique identifier 22 associated with the user profile 14 for allowing identification of the registered user 16 and corresponding account details 18 by a banking institution 24 used by a payer 26 in order to permit a gratuity payment 28 from the payer 26 into the account, typically in the form of a digital wallet 20, of the registered user 16.

The database 12 is in the form of a data storage device (not shown) which is in the form of any one or more of the group including an HDD (Hard Disk Drive), SSD (Solid State Drive), external hard drive, USB flash drive, memory card, optical disc, magnetic tapes, NAS (Network Attached Storage), server, peer-to-peer network, cloud storage, and RAID (Redundant Array of Independent Disks), typically being in the form of a cloud-based storage.

A registration means 30 is provided for allowing a user 32 to sign up and create a user profile 14 for use with the gratuity system 10. The registration means 30 includes a verification means (not shown) for verifying the identity of a user 32 desirous of registering. The verification means (not shown) is configured to compare input identification details (not shown) against those contained on an official database (not shown) whereupon matching of details typically yields successful verification. The official database (not shown) is in the form of a governmental database or a financial database managed by a banking institution. The registration means 30 is configured to create the user's profile 14, digital wallet 20 and unique identifier 22 and store the associated information on the database 12. It is to be appreciated that the registration means 30 is configured to comply with the FICA (Financial Intelligence Centre) Act 38 of 2001 of South Africa when registering a user. The registration means 30 is remotely operable wherein users 32 are able to use a dedicated application installed on a mobile device or a webpage accessible by an internet browser to carry out the registration process.

The identification information (not shown) of the registered user includes any one or more of the group including full names, surnames, identification number, passport number, residential address, employer address, e-mail address, and phone number. The identification information (not shown) includes biometric information (not shown) of the registered user. The biometric information (not shown) includes any one or more of the group including a fingerprint, facial scan, eye scan, voice recording, and the like.

The digital wallet 20 is linked to a bank account 34 in the name of a digital wallet service provider 36. The digital wallet service provider 36 provides digital wallets 20 to registered users 16. The digital wallet service provider 36 provides hosting and management services in relation to the digital wallets 20. The bank account 34 is held with any suitable banking institution. The details 18 of the digital wallet includes account information of the bank account 34 of the digital wallet service provider 36 and identification information (not shown) of the registered user's specific digital wallet 20. It is to be appreciated that both account information and digital wallet identification information is required in order to effect payment into the bank account 34 of the digital wallet service provider 36 and reflect the payment in the digital wallet 20 of the registered user 16. The details 18 of the digital wallet 20 includes any one or more of the group including associated banking institution, branch code, account type, account number, digital wallet identification code, and the like.

The digital wallet 20 is configured to receive conventional monetary payments or digital currency payments, the type of payment typically reflecting within the digital wallet 20 of the registered user 16. The digital currency payment can be in the form of a cryptocurrency payment or a currency of a loyalty reward program. The loyalty reward program currency can be in the form of eBucks, Discovery Miles, and the like. The digital currency can be in the form of airtime.

The digital wallet 20 is configured to allow the registered user 16 to transact with merchants or retailers, typically those associated with the gratuity system 10, at their till points. The digital wallet 20 can be configured to allocate a percentage of funds to any one or more of the group including a retirement fund, pension fund, life insurance policy, funeral policy, disability fund, medical aid, education fund, loan, bond repayment, vehicle finance, and the like. Funds in the digital wallet 20 can be used to obtain shelter, beds, food, and the like. It is to be appreciated that funds in the digital wallet 20 can be used to pay for anything provided by a partnered goods or service provider.

A discount system (not shown) is provided for offering discounts to registered users 16 using funds contained in their digital wallet 20 to purchase goods or services. The discounts offered can be specific to any one or more of the group including a specific product, merchant, service, and service provider. An associated merchant or service provider may receive incentives for offering such discounts, such as receiving Social Development funding or receiving BBBEE points. Companies manufacturing products which are sold to registered users using funds in their digital wallet may provide rebates to specific stores stocking their products.

The registered user 16 is typically in the form of a worker (not shown) performing a service. More specifically, the registered user 16 is in the form of any one or more of the group of workers including petrol attendants, security guards, car guards, waitrons, hotel staff, domestic staff, gardeners, flight cabin crew, cleaning staff, bartenders, golf caddies, drivers, beauticians, hair dressers, game rangers, domestic workers, buskers and the like. It is to be appreciated that the above list is by no means exhaustive and many other workers can be suited to benefit from the gratuity system 10.

The unique identifier 22 is machine-readable, typically being in the form of a machine-readable image or code (not shown). Typically, the unique identifier 22 is configured to be readable by a mobile computing device 38 of the payer 26, wherein the mobile computing device 38 is in the form of any smart device, such as a tablet, smart phone, typically having a camera. Typically, the unique identifier is in the form of a QR (Quick Response) code.

The banking institution 24 is in the form of any suitable banking institution which the payer 26 utilises to manage its funds.

The payer 26 is in the form of any entity wishing to make a gratuity payment 28 to a registered user 16. Typically, the payer 26 is in the form of a member of the public having a mobile computing device capable of reading the unique identifier 22 of the registered user 16 and having a linked payment application (not shown) installed on their mobile computing device. The linked payment application (not shown) is in the form of a banking application or a payment application such as, Snapscan or Zapper, for example.

The gratuity payment 28 is in the form of a conventional monetary payment. Alternatively, the gratuity payment can be in the form of a digital currency payment which can be in the form of a payment of a cryptocurrency or payment of a unit of a loyalty reward program.

An incentivising means (not shown) is provided for incentivising the public to effect gratuity payments via the gratuity system 10. The incentivising means (not shown) is in the form of a reward system (not shown) for rewarding a payer 26 upon effecting a gratuity payment 28 via the gratuity system 10. The reward system (not shown) can be configured to issue a currency of a loyalty reward program to the payer 26. The reward system (not shown) can be configured to issue a voucher or coupon to be used at an associated retailer. The incentivising means (not shown) includes governmental subsidisation into a retirement fund, pension fund, unemployment fund, and the like. The incentivising means (not shown) includes tax benefits wherein gratuity payments via the gratuity system are tax deductable, typically wherein a certificate in terms of Section 18A of the Income Tax Act 58 of 1962 of South Africa is issued to the payer.

A recording means (not shown) is provided for recording performance statistics (not shown) of employees (not shown) who are registered users 16 of the gratuity system 10. The performance statistics (not shown) includes sales and gratuity information (not shown) of the employees (not shown), typically employees (not shown) employed by a specific employer (not shown).

A purchase recording means (not shown) is provided for recording details of all purchases using funds contained in a registered user's digital wallet 20. Purchase details can include product information, price, store location, and the like.

In use, after completion of a service by a registered user 16, the user 16 would present its unique identifier 22, in the form of a QR code, to a payer 26. The payer 26 would then open up either a banking application or a payment application on their smart phone 38, navigate to a scan to pay function within the application and use a camera (not shown) of the smart phone 38 to scan the worker's QR code 22. Upon reading of the QR code 22, the smart phone 38 receives identification and account information 18 of the user 16 from the QR code 22. The account details 18 includes an account number of an account to receive the payment and identification details of the worker's specific digital wallet 20 for allowing the payment to be allocated to the worker's digital wallet 20. The information is communicated to the payer's banking institution 24 via the banking or payment application for verification. Once verified, the banking institution 24 returns positive communication to the smart phone 38 which then prompts the payer 26 to enter a payment amount. After entering the amount and selecting a pay button (not shown) to initiate a payment instruction to the banking institution 24, payment is effected from the payer's bank account 40 to the account 42 of the digital wallet service provider 36, which reflects in the worker's digital wallet 20, typically reflecting immediately. Should connectivity be lacking, the various processes are put on hold and continued when connectivity is re-established at a later stage, in such a case, the payment would only reflect once connectivity is re-established and verification was successful.

It is, of course, to be appreciated that the gratuity system in accordance with the invention is not limited to the precise constructional and functional details as hereinbefore described with reference to the accompanying drawings and which is varied as desired.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified. It is further to be understood that the examples are provided for illustrating the invention further and to assist a person skilled in the art with understanding the invention and is not meant to be construed as unduly limiting the reasonable scope of the invention.

The inventor believes that the gratuity system in accordance with the present invention is advantageous in that it formalises gratuity payments to people who usually do not have access to banking institutions. The gratuity system is believed improve a likelihood and quantity of gratuity payments to service personnel which would in turn, improve overall earnings of the service personnel. Furthermore, with an improvement in earnings would come improved job quality and satisfaction. Yet even further, doing away with physical gratuity payments would reduce safety risks associated with theft.

1. A gratuity system including:—
a database containing a profile of a registered user which includes:—
identification information of the registered user; and
details of an account linked to the registered user; and
a unique identifier associated with the user profile for allowing identification of the registered user and corresponding account details by a banking institution used by a payer in order to permit a gratuity payment from the payer into the account of the registered user.

2. A gratuity system as claimed in claim 1 wherein a registration means is provided for allowing a user to sign up and create a user profile for use with the gratuity system.

3. A gratuity system as claimed in claim 2 wherein the registration means includes a verification means for verifying the identity of a user desirous of registering, wherein the verification means is configured to compare input identification details against those contained on an official database whereupon matching of details typically yields successful verification.

4. A gratuity system as claimed in claim 3 wherein the official database is in the form of a governmental database or a financial database managed by a banking institution.

5. A gratuity system as claimed in claim 3 wherein the identification information of the registered user includes any one or more of the group including name, full names, surnames, identification number, passport number, residential address, employer address, e-mail address, phone number, and biometric information.

6. A gratuity system as claimed in claim 1 wherein the account is in the form of a bank account which is in the name of the registered user.

7. A gratuity system as claimed in claim 6 wherein the bank account is in the name of a digital wallet service provider which provides a digital wallet to registered users.

8. A gratuity system as claimed in claim 7 wherein the account is configured to receive conventional monetary payments or digital currency payments, wherein the type of payment reflects within the digital wallet of the registered user.

9. A gratuity system as claimed in claim 8 wherein the digital currency payments are in the form of a cryptocurrency payment or a currency of a loyalty reward program.

10. A gratuity system as claimed in claim 8 wherein the digital currency is in the form of airtime.

11. A gratuity system as claimed in claim 1 wherein the account is configured to allow the registered user to transact with merchants or retailers, typically those associated with the gratuity system, at their till points.

12. A gratuity system as claimed in claim 1 wherein the account is configured to allocate a percentage of funds to any one or more of the group including a retirement fund, pension fund, life insurance policy, funeral policy, disability fund, medical aid, education fund, loan, bond repayment, vehicle finance, financial services, financial advice, estate planning, and debt counselling.

13. (canceled)

14. A gratuity system as claimed in claim 1 wherein the registered user is in the form of any one or more of the group of workers including petrol attendants, security guards, car guards, waitrons, hotel staff, domestic staff, gardeners, flight cabin crew, cleaning staff, bartenders, golf caddies, drivers, beauticians, hair dressers, game rangers, domestic workers and busker.

15. A gratuity system as claimed in claim 1 wherein the registered user is in the form of a company or charitable or non-profit organisation.

16. A gratuity system as claimed in claim 1 wherein the registered user is in the form of a group-type or representative user which may represent a plurality of associated workers or individuals.

17. (canceled)

18. (canceled)

19. (canceled)

20. (canceled)

21. A gratuity system as claimed in claim 1 wherein the unique identifier is configured to be readable by a mobile computing device of the payer, wherein the mobile computing device is in the form of any smart device having a camera.

22. (canceled)

23. (canceled)

24. A gratuity system as claimed in claim 1 wherein the unique identifier is in the form of a device capable of communicating with a mobile computing device of the payer for transferring information and account details of the registered user to the mobile computing device to enable identification of the registered user by the payer's banking institution in order to set up and permit the gratuity payment.

25. (canceled)

26. (canceled)

27. (canceled)

28. A gratuity system as claimed in claim 1 wherein an incentivising means is provided for incentivising the public to effect gratuity payments via the gratuity system.

29. A gratuity system as claimed in claim 28 wherein the incentivising means is in the form of a reward system for rewarding a payer upon effecting a gratuity payment via the gratuity system.

30. A gratuity system as claimed in claim 28 wherein the incentivising means includes tax benefits wherein gratuity payments via the gratuity system are tax deductible.
